(19) United States
(12) Patent Application Publication
(10) Pub. No.: US 2018/0290703 A1
(43) Pub. Date: Oct. 11, 2018

(54) SEAT FOR BICYCLES

(71) Applicant: Mu-Rong Li, Taichung City (TW)

(72) Inventor: Mu-Rong Li, Taichung City (TW)

(21) Appl. No.: 15/480,379

(22) Filed: Apr. 6, 2017

(51) Int. Cl. B62J 1/08; B62J 1/18

(52) U.S. Cl. CPC B62J 1/08; B62J 1/18

(57) ABSTRACT

A bicycle seat includes a support having a base and two rails. A ridge is formed along the periphery of the top of the base so as to define an installation recess between the ridge and the top of the base. The two rails are connected to the underside of the base and spaced apart from each other. A pad is engaged with the installation recess and has a groove defined along the periphery of the underside thereof. The ridge is engaged with the groove to directly connect the pad to the base. A recessed area is defined in the top of the pad to provide comfort to the users.

### BACKGROUND OF THE INVENTION

### 1. Fields of the Invention

The present invention relates to a seat, and more particularly, to a seat for a bicycle and the seat is light in weight and provides comfort to the users.

### 2. Descriptions of Related Art

The conventional bicycle seats are roughly cataloged into two types, one of which is the sport seat which is a narrow and hard, and the other one is the leisure seat which is wide and soft. The sport seats are used for sport cycling use, and which include a groove along the axis of the seat. The sport seats are suitable for quickly treading. The leisure seats are used for relax cycling use and which are not suitable for quickly treading. Nevertheless, the sports are hard and cannot provide comfort to the users, and may hit the users' bottom.

Generally, the sport seats are made by carbon-fiber which are light in weight and includes a coat 5 coated to the seats as shown in FIG. 8. The coat 5 is folded inward along the lower edge of the seat and stapled. The coat 5 may be flipped out and creates wrinkles. The wrinkles may affect the concentration of the users during competition.

The present invention intends to provide a bicycle seat which eliminates the shortcomings mentioned above.

### SUMMARY OF THE INVENTION

The present invention relates to a bicycle seat and comprises a support having a base and two rails. A ridge is formed along the periphery of the top of the base. An installation recess is formed between the ridge and the top of the base. The two rails are connected to the underside of the base and spaced apart from each other. A pad is engaged with the installation recess and has a groove defined along the periphery of the underside thereof. The ridge is engaged with the groove to connect the pad to the base. A recessed area is defined in the top of the pad.

Preferably, the base includes a front portion and a rear portion. The recessed area is located corresponding to the middle portion of the rear portion. The middle portion of the rear portion includes a left portion and a right portion. The shaped of the underside of the pad is complementary to the contour of the top of the base so that the pad is matched with the base.

Preferably, the pad is adhered to the base.

Preferably, the pad has a first connection portion, and a second connection portion is formed to the base and located corresponding to the first connection portion. The first connection portion is detachably connected to the second connection portion.

Preferably, the two rails are integrally formed with the base.

Preferably, the two rails are connected to the base.

Preferably, the base is made of carbon-fibers and the pad is made by foam material.

The primary object of the present invention is to provide a bicycle seat which is easily assembled, and there is no coat needed, and no wrinkles will be created

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle seat of the present invention;

FIG. 2 is an exploded view of the bicycle seat of the present invention;

FIG. 3 is a cross sectional view, taken along line 3-3 in FIG. 1;

FIG. 4 is an enlarged cross sectional view to show the connection between the base and the pad;

FIG. 5 shows that the base and the rails are integrally formed to each other;

FIG. 6 shows that the rails are connected to base;

FIG. 7 shows that the pad is detachably connected to the base, and

FIG. 8 shows the conventional bicycle seat.

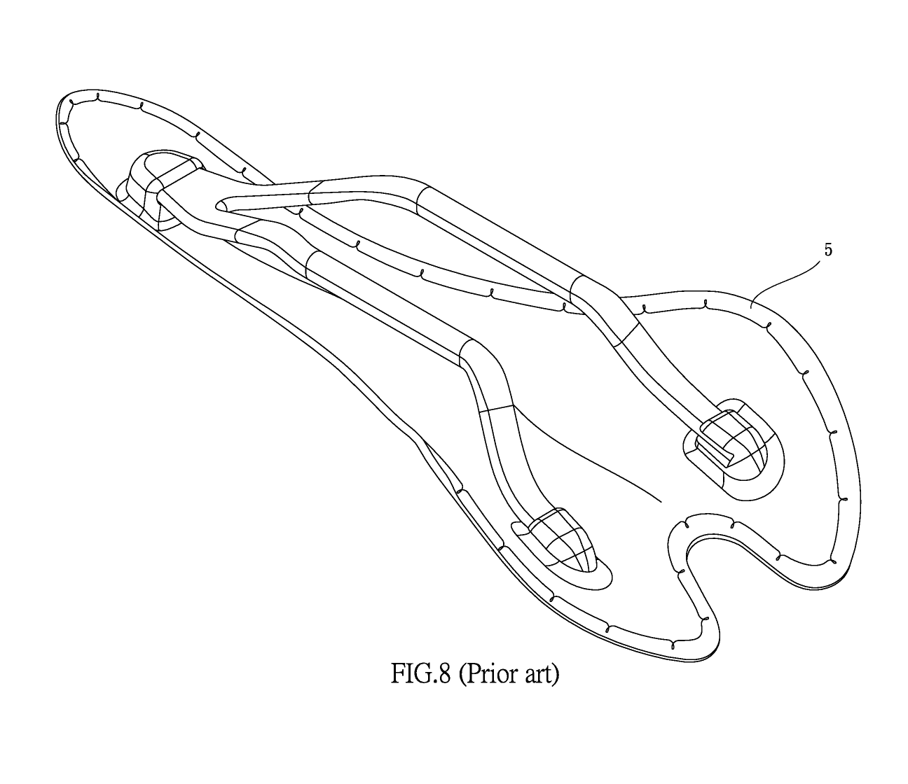

### DETAILED DESCRIPTION OF THE PREFERRED EMBODIMENT

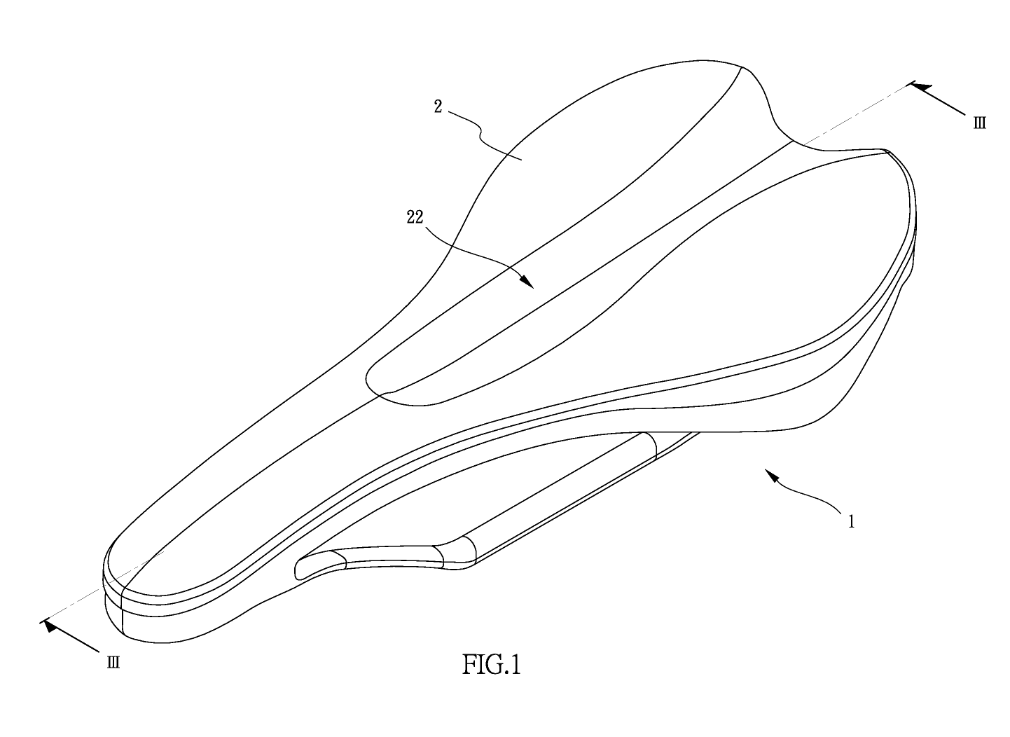

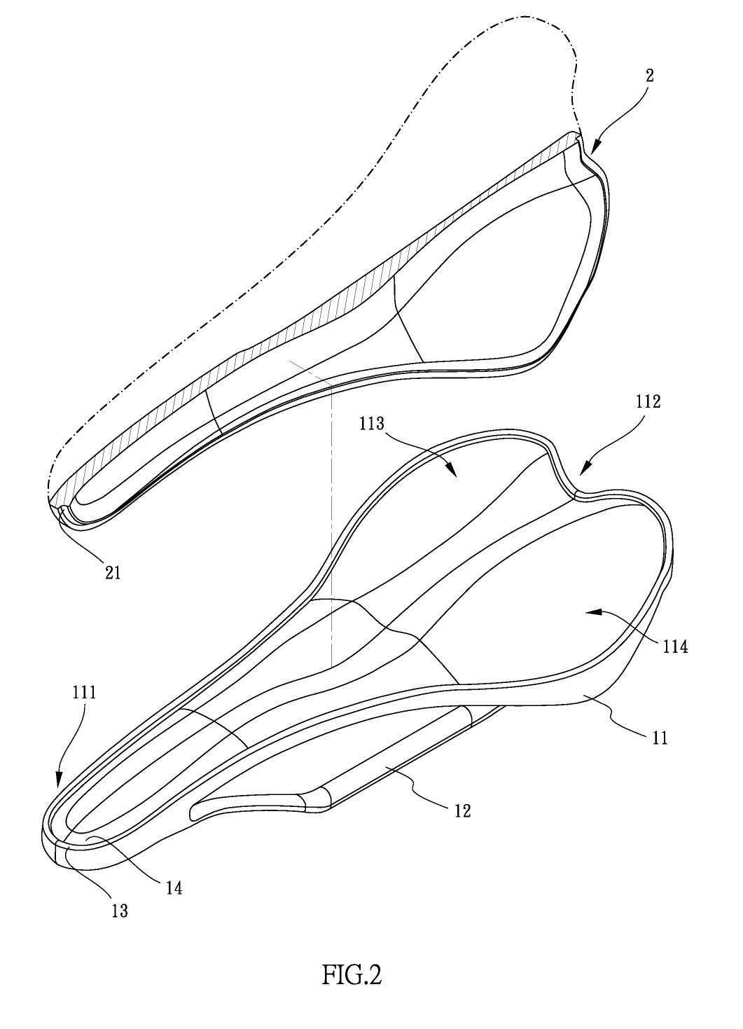

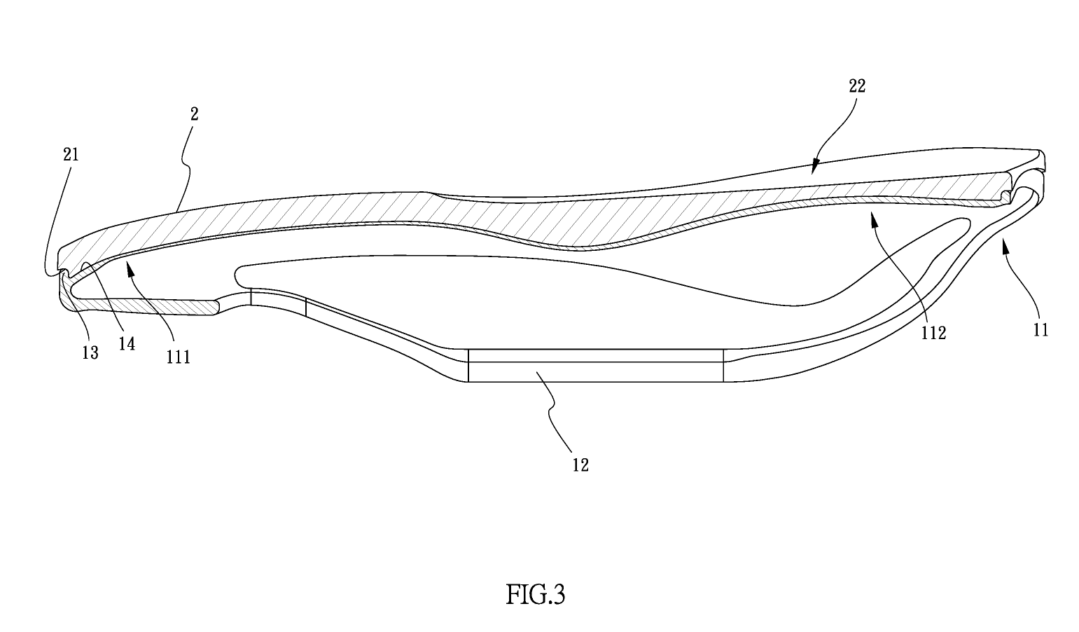

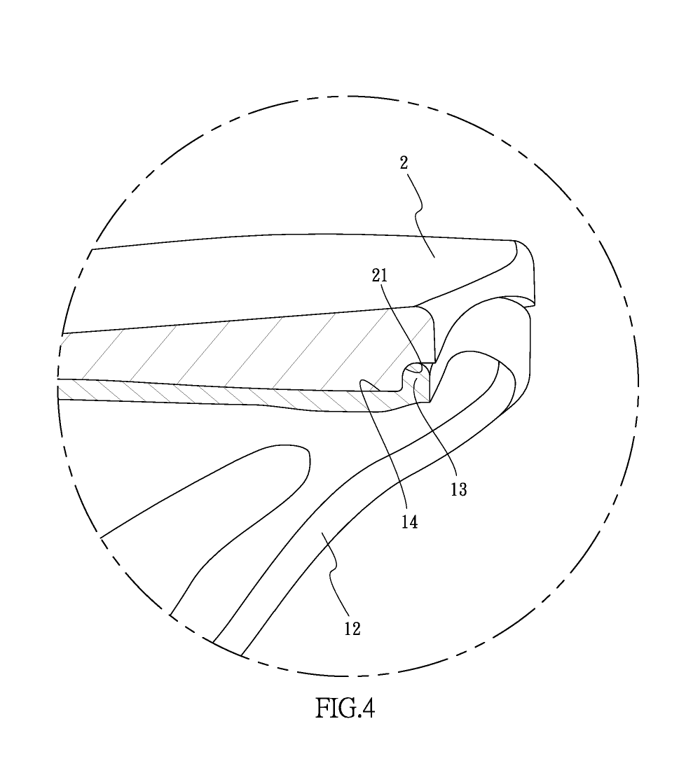

Referring to FIGS. 1 to 5, the bicycle seat of the present invention comprises a support 1 having a base 11 and two rails 12. The base 11 includes a front portion 111 and a rear portion 112, wherein the front portion 111 is a narrow and elongate portion. The rear portion 112 is a wider portion. A ridge 13 is formed along the periphery of the top of the base 11. An installation recess 14 is formed between the ridge 13 and the top of the base 11. The two rails 12 are connected to the underside of the base 11 and spaced apart from each other. In this embodiment, the two rails 112 are in a V-shaped form.

A pad 2 is engaged with the installation recess 14 and has a groove 21 defined along the periphery of the underside thereof. The ridge 13 is engaged with the groove 21 so as to directly connect the pad 2 to the base 11. A recessed area 22 is defined in the top of the pad 2. The pad 2 is engaged with the installation recess 14 such that there will be no stapling step needed and no wrinkles. The recessed area 22 is benefit for male users. The assembling is easy and convenient without stapling.

Specifically, the recessed area 22 is located corresponding to the middle portion of the rear portion 112. The length of the recessed area 22 is longer than a half length of the base 11. The middle portion of the rear portion 112 includes a left portion 113 and a right portion 114. The left and right portions 113, 114 are protruded portions. The shaped of the underside of the pad 2 is complementary to the contour of the top of the base 11 so that the pad 2 is matched with the base 11. In one embodiment, the pad 2 is adhered to the base 11.

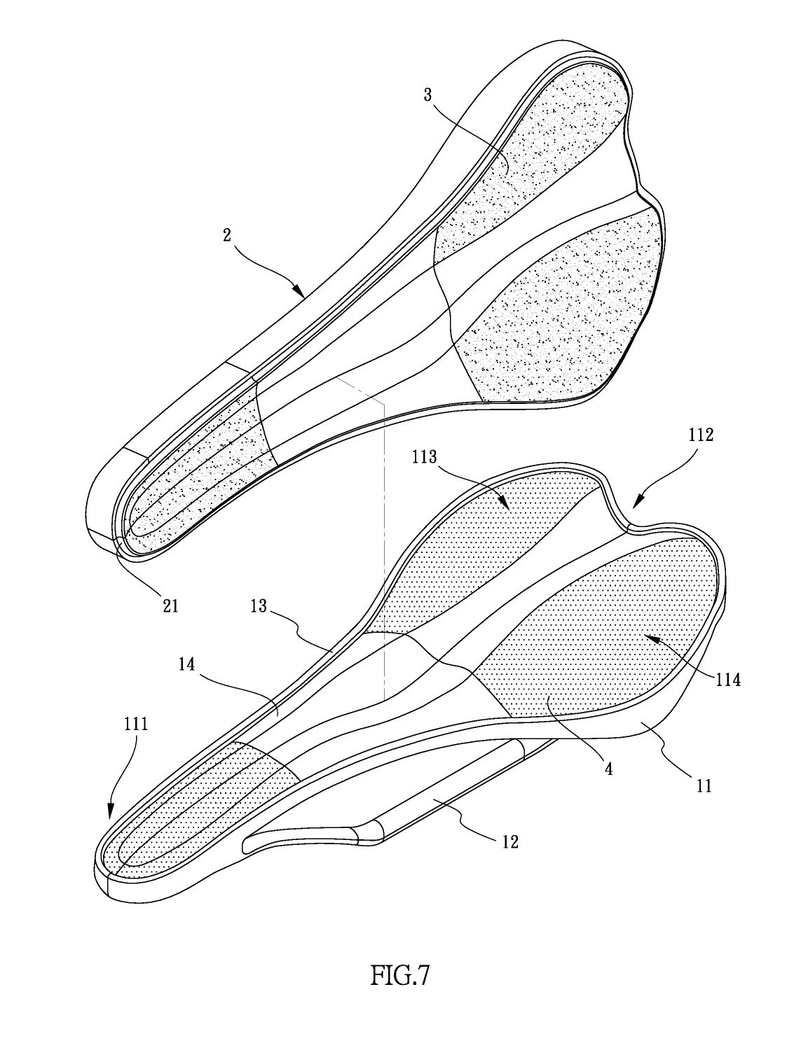

In another embodiment, the pad 2 has a first connection portion 3, and a second connection portion 4 is formed to the base 11 and located corresponding to the first connection portion 3. The first connection portion 3 is detachably connected to the second connection portion 4 by using magnets, snapping members, or hook-and-loop strips. The pad 2 is detachably connected to the base 11 so that the users can use their own pads 2 as needed as shown in FIG. 7.

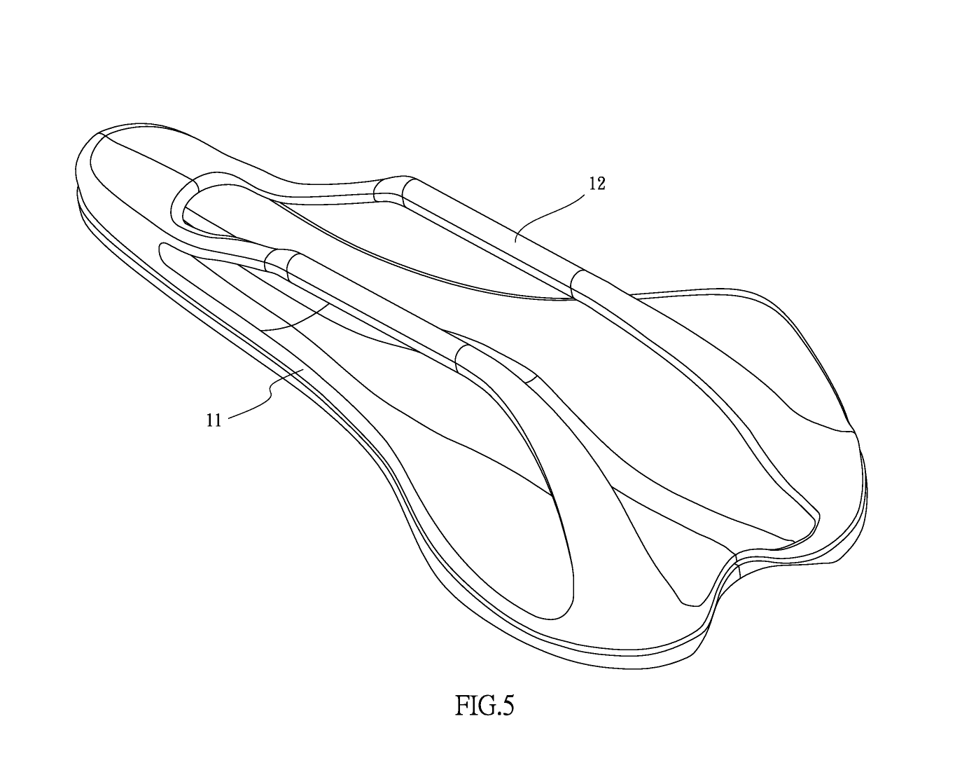

As shown in FIG. 5, the rails 12 are integrally formed with the base 11, and made by carbon-fibers. T pad 2 is made by foam material.

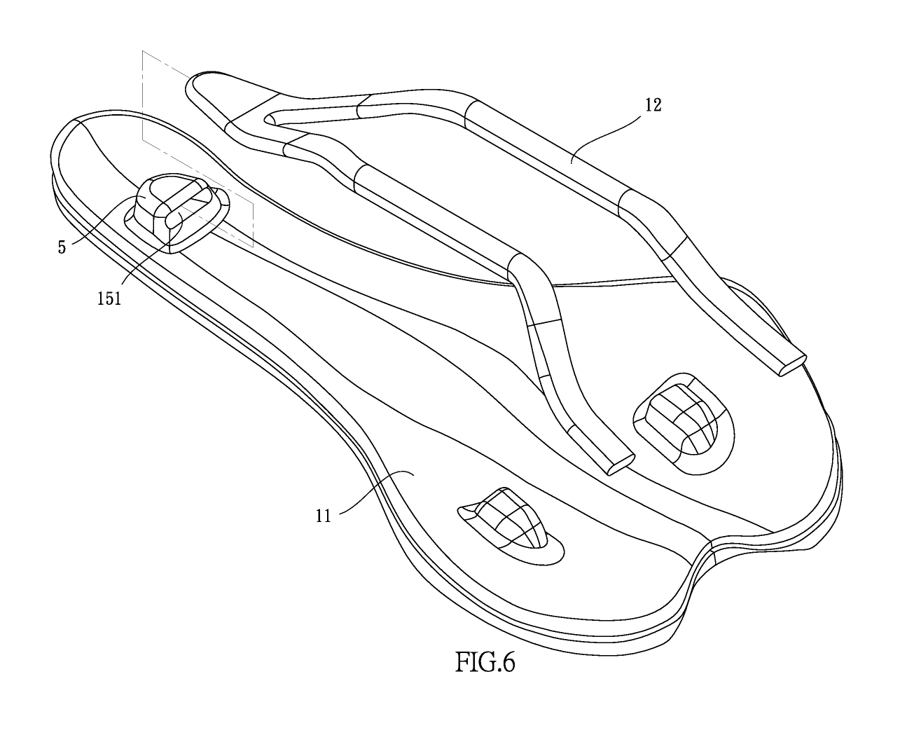

As shown in FIG. 6, the two rails 12 are connected to the base 11. Specifically, there are two positioning blocks 5 connected to the underside of the rear end of the base 11, and one positioning block 5 on the underside of the front end of the base 11. The three positioning blocks 5 are located at three corners of a triangle, and each positioning block 5 has a hole 151. The V-shaped rails 12 are inserted into the holes 151 of the three positioning blocks 5.

The features of the present invention are that the pad 2 is directly engaged with the installation recess 14 of the base 11 without stapling steps. The wrinkles seen on the conventional bicycle seats are avoided. The bicycle seat is comfort when in use, and includes simple structure.

While we have shown and described the embodiment in accordance with the present invention, it should be clear to those skilled in the art that further embodiments may be made without departing from the scope of the present invention.

What is claimed is:

1. A bicycle seat comprising:
a support (1) having a base (11) and two rails (12), a ridge (13) formed along a periphery of a top of the base (11), an installation recess (14) formed between the ridge (13) and the top of the base (11), the two rails (12) connected to an underside of the base (11) and spaced apart from each other, and
a pad (2) engaged with the installation recess (14) and having a groove (21) defined along a periphery of an underside thereof, the ridge (13) engaged with the groove (21), a recessed area (22) defined in a top of the pad (2).

2. The bicycle seat as claimed in claim 1, wherein the base (11) includes a front portion (111) and a rear portion (112), the recessed area (22) is located corresponding to a middle portion of the rear portion (112), the middle portion of the rear portion (112) includes a left portion (113) and a right portion (114), a shaped of the underside of the pad (2) is complementary to a contour of the top of the base (11) so that the pad (2) is matched with the base (11).

3. The bicycle seat as claimed in claim 1, wherein the pad (2) is adhered to the base (11).

4. The bicycle seat as claimed in claim 1, wherein the pad (2) has a first connection portion (3), a second connection portion (4) is formed to the base (11) and located corresponding to the first connection portion (3), the first connection portion (3) is detachably connected to the second connection portion (4).

5. The bicycle seat as claimed in claim 1, wherein the two rails (12) are integrally formed with the base (11).

6. The bicycle seat as claimed in claim 1, wherein the two rails are connected to the base (11).

7. The bicycle seat as claimed in claim 1, wherein the base (11) is made of carbon-fibers and the pad (2) is made by foam material.
